(19) United States
(12) Patent Application Publication
(10) Pub. No.: US 2007/0241288 A1
(43) Pub. Date: Oct. 18, 2007

(54) ULTRAVIOLET LAMP FOR WATER STERILIZATION

(76) Inventor: Tsung-Yang Wang, Pingchin City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/279,995

(22) Filed: Apr. 17, 2006

(51) Int. Cl. C02F 1/32

(52) U.S. Cl. 250/436

(57) ABSTRACT

An ultraviolet lamp for water sterilization in accordance with the present invention comprises an illuminating unit, a base, an O-ring, a collar and a quartz tube. By clamping the O-ring between the base and the collar to provide a compressing sealing efficiency, water-tightness efficiency is improved and change convenience of the illuminating unit is obtained. Wherein, the illuminating unit is composed of an upper filament and a lower filament enclosed inside a quartz inner tube and then further protected by the O-ring so that a dual-protection to the illuminating unit is achieved. Thereby, the ultraviolet lamp has excellent water-tightness efficiency to extend its lifespan and is convenient and time-saving in assembly and repair.

### BACKGROUND OF THE INVENTION

1. Field of the Invention

The present invention relates to an ultraviolet lamp, and more particularly to an ultraviolet lamp for water sterilization that contains an O-ring preventing water permeating into the lamp to provide excellent water-tightness efficiency and convenience for changing an illuminating unit inside the ultraviolet lamp.

2. Description of Related Art

A conventional ultraviolet lamp for water sterilization is assembled by applying rubber sealant between a quartz outer tube and a base, wherein the rubber sealant has poor water-tightness efficiency poor and is difficult to be removed when a user wants to change an illuminating tube within the quartz outer tube. Therefore, the conventional ultraviolet lamp easily malfunctions because of water permeation and is troublesome and time-consuming in repair. Moreover, when the rubber sealant is scratch out, the quartz tube may be damaged so that safety reliability of the conventional ultraviolet lamp is greatly decreased upon high pressure operation.

As shown in FIG. 5, the conventional ultraviolet lamp in cross-sectional side view that shows the quartz outer tube 5 and the base 7 is sealed by the rubber sealant 8 at joint seams. Because the rubber sealant does not cause compressive sealing and has thus poor water-tightness so that water permeation happens often at joints in the conventional ultraviolet lamp. Moreover, the rubber sealant 8 has to be completely removed for re-sealing so that repair of the conventional ultraviolet lamp is troublesome and time-consuming.

### SUMMARY OF THE INVENTION

To overcome the drawbacks of the conventional ultraviolet lamp for water sterilization, an improved ultraviolet lamp is provided to eliminate the drawbacks.

A main objective of the present invention is to provide an ultraviolet lamp for water sterilization that has excellent water-tightness efficiency to extend usage life of the ultraviolet lamp for water sterilization.

Another objective of the present invention is to provide an ultraviolet lamp for water sterilization that can be conveniently and easily repaired.

To achieve the foregoing objectives, the ultraviolet lamp for water sterilization comprises:

an illuminating unit with a mounting board;

a base sleeving the illuminating unit and engaged the mounting board;

a collar mounted on the base;

a quartz outer tube tightly abutting the collar and the base to enclose the illuminating unit with the mounting board, the base and the collar; and

an O-ring compressively clamped between the base and collar to provide water-tightness efficiency.

Thereby, the illuminating unit is enclosed inside a quartz inner tube and then further protected by the O-ring so that the ultraviolet lamp has excellent water-tightness efficiency.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an ultraviolet lamp for water sterilization in accordance with the present invention;

FIG. 2 is a perspective view of the ultraviolet lamp in FIG. 1;

FIG. 3 is a cross-sectional side view of the ultraviolet lamp in FIG. 2;

FIG. 4 is an operational cross-sectional side view of the ultraviolet lamp in FIG. 3, wherein the ultraviolet lamp is combined with a water treatment column; and

FIG. 5 is a cross-sectional side view of a conventional ultraviolet lamp for water sterilization in accordance with the prior art.

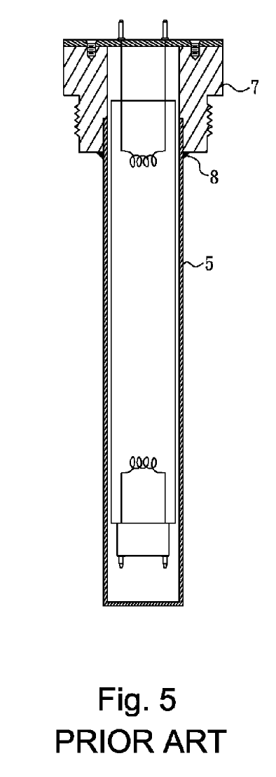

### DETAILED DESCRIPTION OF THE PREFERRED EMBODIMENT

An ultraviolet lamp for water sterilization in accordance with the present invention comprises an illuminating unit, a base, an O-ring, a collar and a quartz tube. By clamping the O-ring between the base and the collar to provide a compressive sealing efficiency, water-tightness efficiency is improved and change convenience of the illuminating unit is obtained. Wherein, the illuminating unit is composed of an upper filament and a lower filament enclosed inside a quartz inner tube and then further protected by the O-ring so that a dual-protection to the illuminating unit is achieved. Thereby, the ultraviolet lamp has excellent water-tightness efficiency to extend its lifespan and is convenient and time-saving in assembly and repair.

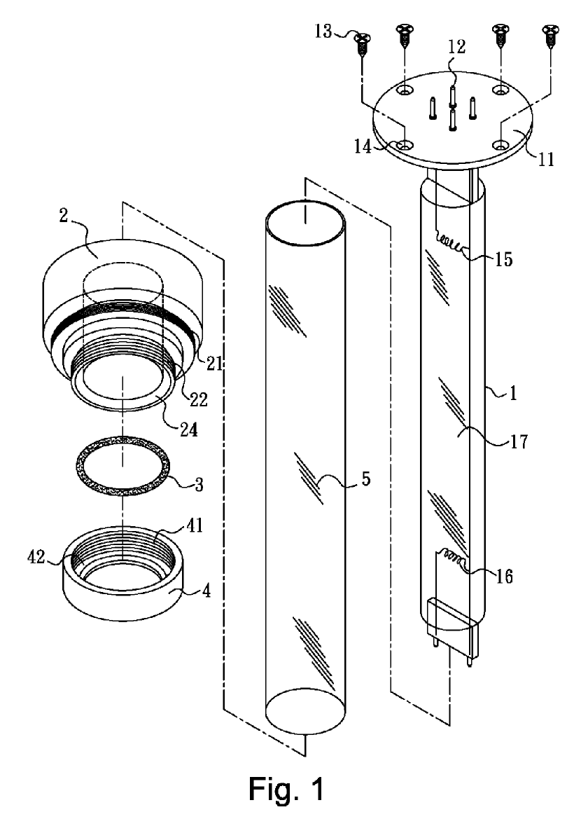

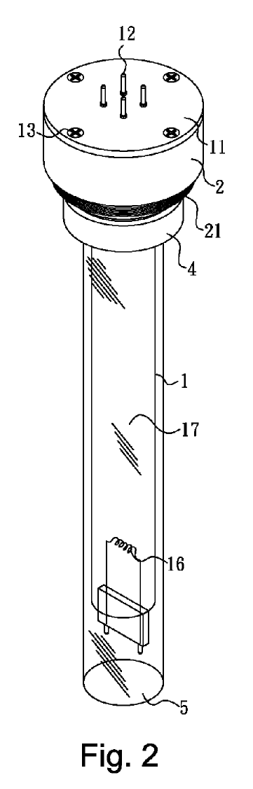

With reference to FIGS. 1 and 2, a preferred embodiment of the ultraviolet lamp for water sterilization comprises an illuminating unit 1, a base 2, an O-ring 3, a collar 4 and a quartz outer tube 5. The illuminating unit 1 comprises a mounting board 11 with multiple sunken holes 14, multiple electrodes 12, multiple screws 13, an upper filament 15, a lower filament 16 and a quartz inner tube 16, wherein the multiple screws 13 correspondingly engage the multiple sunken holes 14 to combine the illuminating unit 1 with the base 2. The electrodes 12 extend out of the mounting board 11 to serve as power input contacts for the upper filament 15 and the lower filament 16 both are enclosed inside the quartz inner tube 17. The quartz inner tube 17 is made of quartz glass tube to protect the upper filament 15 and the lower filament 16.

The base 2 is an annular body with an inner diameter about the same with an outer diameter of the quartz outer tube 5. The base 2 has an outer periphery and an upper thread 21 defined on a middle of the outer periphery to adapt to connect with a water treatment column. The base 2 further has a threaded connecting end 22 engaging with the collar 4 and an annular curved groove 24 defined in an inner side of the threaded connecting end 22 to partially receive the O-ring 3.

The O-ring 3 is made of resilient pore-free material such as rubber and correspondingly engages the annular curved groove 24 on the base 2. Therefore, when the base 2 and the collar 4 combine with each other, the O-ring 3 is clamped therebetween to prevent fluids leakage or permeation and to provide excellent water-tightness efficiency.

The collar 4 is an annular cap and has an inner diameter about the same with the outer diameter of the quartz tube 5. The collar 4 has an inner thread 41 to correspondingly engage the threaded connecting end 22 of the base 2 and further has an annular curved groove 42 aligning to the annular curved groove 24 on the base 2.

The quartz outer tube 5 being transparent has a closed end and an opening end and combines with the base 2 to protect the illuminating unit 1 when the ultraviolet lamp is deposed in water for sterilization.

As shown in FIG. 2, the ultraviolet lamp for water sterilization in assembly is presented.

The mounting board 11 sequentially combines with the base 2 and the collar 4, wherein the O-ring 3 is clamed between the base and the collar 4. The mounting board 11 attaches to the base 2 by the multiple screws 13 and has extruded electrodes 12 to serve as power input contacts. The upper thread 21 on the base 2 is for combining the base 2 with the water treatment column. The illuminating unit 1 is completely enclosed by the mounting board 11, the base 2, the collar 4 and the quartz outer tube 5 after the quartz outer tube 5 is wedged into and secured on the base 2 and the collar 4.

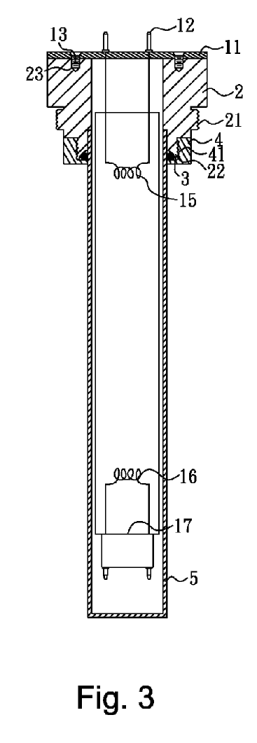

As shown in FIG. 3, the ultraviolet lamp for water sterilization in cross-sectional view in assembly is presented.

The mounting board 11 attaches to the base 2 by engaging the multiple screws 13 with multiple corresponding screw holes 23 on the base 2. The threaded connecting end 22 of the base 2 screws to the inner thread 41 on the collar 4 so that the O-ring 3 is clamped between the base 2 and the collar 4 to provide water-tightness efficiency. The quartz outer tube 5 inserts into the base 2 and the collar 4 at its opening end tightly abuts inner peripheries of the base 2 and the collar 4 for combination. The upper filament 15 and the lower filament 16 are enclosed inside the quartz inner tube 17 and then accommodated inside the quartz outer tube 15 with the O-ring 3 so that the ultraviolet lamp provides a dual-protection.

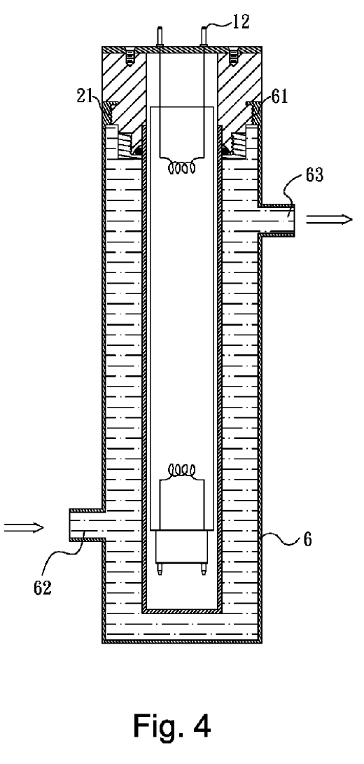

As shown in FIG. 4, the ultraviolet lamp for water sterilization is cooperated with the water treatment column 6 in operation.

The water treatment column 6 has a top end, a bottom end, an inner thread 61 to detachably engage the upper thread 21 on the base 2. Moreover, the water treatment column 6 has an inlet 62 formed near the bottom end and an outlet formed near the top end to allow water flowing through the water treatment column 6 after sterilization.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. An ultraviolet lamp for water sterilization comprising:
an illuminating unit with a mounting board;
a base sleeving the illuminating unit and engaged the mounting board;
a collar mounted on the base;
a quartz outer tube tightly abutting the collar and the base to enclose the illuminating unit with the mounting board, the base and the collar; and
an O-ring compressively clamped between the base and collar to provide water-tightness efficiency.

2. The ultraviolet lamp for water sterilization as claimed in claim 1, wherein the base is an annular body with an inner diameter about the same with an outer diameter of the quartz outer tube and has
a periphery;
an upper thread defined at a middle portion on the periphery; and
a threaded connecting end;
wherein, the collar is an annular cap with an inner diameter about the same with an outer diameter of the quartz tube and has an inner thread to correspondingly engage the threaded connecting end of the base.

3. The ultraviolet lamp for water sterilization as claimed in claim 2, wherein the threaded connecting end further has an annular curved groove to correspond with the O-ring;
wherein, the collar further has an annular curved groove aligning to the annular curved groove of the base to correspond with the O-ring.

4. The ultraviolet lamp for water sterilization as claimed in claim 1, wherein the quartz outer tube has a closed end and an opening end.
